(19) United States
(12) Patent Application Publication
(10) Pub. No.: US 2011/0312230 A1
(43) Pub. Date: Dec. 22, 2011

(54) NON-INFLATED, COMPONENT-CORE-ENCAPSULATED RAFT AND RELATED CONSTRUCTION METHODOLOGY

(76) Inventors: Timothy P. Zuber, Woodinville, WA (US); Russell A. Monk, Salem, OR (US)

(21) Appl. No.: 13/157,842

(22) Filed: Jun. 10, 2011

Related U.S. Application Data
(60) Provisional application No. 61/356,010, filed on Jun. 17, 2010.

(51) Int. Cl. B63B 35/613; B23P 19/04; B23P 11/00; B63B 35/58; B32B 7/08

(52) U.S. Cl. 441/35; 156/92; 29/428; 29/460

(57) ABSTRACT

A robust-skin-encapsulated, non-inflatable raft including (1) shape-establishing body structure in the form of an assembly including (a) perimeter structure defining and at least partially circumsurrounding a deck zone, and (b) deck structure joined to said perimeter structure within said deck zone, and (2) an all-over, encapsulating, penetration-barriering and fracture-resistant, elastomeric, polyurea skin coating applied to the assembly of the perimeter and deck structures within the body structure. The perimeter and deck structures are preferably formed of solid foam material.

### CROSS REFERENCE TO RELATED APPLICATION

This application claims filing-date priority to U.S. Provisional Patent Application Ser. No. 61/1,356,010, filed Jun. 17, 2010, for “Raft Structure and Related Construction Methodology”, the entire disclosure content of which is hereby incorporated herein by reference.

### BACKGROUND AND SUMMARY OF THE INVENTION

This invention pertains generally both to raft structure, and to associated raft-construction methodology. More particularly it relates to non-inflated raft structure featuring a strikingly robust, high-protection-quality, all-over-encapsulating elastomeric skin, or coating, which is applied to a preferably solid-foam, shape-defining buoyancy core structure, or core body structure, and to a methodology for constructing such raft structure.

In general terms, the shape-establishing, preferably entirely foam core structure resides in, and forms, two, main foam-core, or foam core-structure, raft components. These include (1) a selectably-shaped perimeter structure (defined by what we call elongate logs, of special, plural-component construction), the perimeter structure defining a central deck zone also of selectable shape, and (2) a central deck structure, also of special construction and appropriately chooseable shape, which is anchored to the perimeter structure within the central deck zone. Importantly overcoating, binding together, and thereby uniting and stabilizing configurationally, the core-structure components—i.e., the logs and the central deck structure—is the mentioned, high-protection-quality skin coating, which preferably is formed of a very tough and robust, sprayed-on, polyurea, elastomeric material—a material which importantly defines ultimately “how the total raft structure meets, withstands, and reacts to the outside world”.

As will be mentioned later herein, while raft core structure is preferably made entirely of selected, solid, buoyancy foam materials, modifications are possible, and may be desirable in certain instances, involving, at least in part, various other kinds of materials. Representative examples of such other materials will be identified below in this text. The preference, as mentioned, for the use of solid foam materials will form the basis below for substantially the entirety of the description provided herein for the invented raft.

Aspects of the invented, preferred construction methodology feature, among other things, pre-formation, and then specialized assembly, of plural component elements that make up the mentioned preferably foam-core perimeter and deck structures—these elements being created entirely from selected, and appropriately water-jet-profile-cut, sheet solid-foam buoyancy materials. Selected outer-surface areas of the initially assembled, basic core structure then have a sheet-foam wrap adhesively applied to them, and thereafter, the all-important, high-protection-quality, skin coating—preferably elastomeric polyurea, as mentioned—is all-over applied by spraying to, and encapsulating, the entire assemblage of the core and jacketing components.

The terms “raft structure” and “raft” used herein, as well as other, similar, “raft-associated” terms, are meant to refer to both non-engine-powered and engine-powered water vessels of various, specific styles, notwithstanding the fact that a preferred and best-mode embodiment, and manner of practicing the methodology, of the present invention are particularly described and illustrated herein in the context of a non-engine-powered, bilaterally and longitudinally symmetrical, outwardly somewhat conventional looking and generally ovate-shaped, familiar, inflatable-style, “manually-powered” raft.

As will be seen, the raft of the present invention significantly addresses, with predictable and successful survival robustness and assurance, the vulnerability of conventional inflatable “raft” vessels to catastrophic deflating and disabling puncture and fracture wounds, especially in aggressive and dangerous water-transport and maneuvering conditions, such as are found, for examples, in violent, white-water and rocky turbulence zones, in risky human-rescue situations, and in a wide range of military combat settings, just to mention a few. The raft of this invention, in its preferred form, accomplishes this with a remarkably simple and contextually inexpensive, generally above described, polyurea-skinned (an encapsulating skin), principally solid foam core-level construction, and with an impressive design and build-enabling configuration versatility, which collectively offer appreciable advantages over conventional raft structures and associated construction methodologies.

As generally suggested above, the raft of the present invention may be thought of as including two, main, core-level, shape-defining core body structural components. These two components include (1) a perimeter structure, and (2) a deck structure which fits (in the particular raft embodiment which is pictured, and described herein in detail, for illustration purposes) within a circumsurrounded deck zone that is defined centrally within the perimeter structure. Within each of these, two, shape-defining structures, and residing therein in a “core” condition, is, preferably, what may be thought of as a central, solid, foam buoyancy-material body which has been formed, uniquely, entirely from precursor foam sheet material from which the appropriate building shapes, or elements, have been water-jet excised.

The preferred foam core structure residing within the perimeter structure takes the form, uniquely, of what are referred to as plural, elongate logs, each of which is formed, at its center, by a “preliminary log” sandwich stack, or simply a stack, of building-block foam slabs that have been appropriately perimetrally profiled in the excising methodology mentioned just above, these slabs being registry aligned via plural through apertures (or registry apertures) which function with frictionally, threadedly inserted pins or rods, also preferably, though not in all instances necessarily, formed of foam material, that create an appropriate registration profile alignment between the slabs in each log. The logs are endo-bonded to one another through an appropriate surface-contact adhesive, though within each log, per se, there is no need to include any inter-slab bonding mechanism, and none is included. As may be apparent from perimeter-structure description text which is presented above, there is, for that structure's componentry, a four-stage hierarchical language description which is employed herein, including, progressing from the lowest-denominator level: (1) “building-block slab”, or simply “slab”; (2) “preliminary, or precursor, log” (a register-aligned, pinned stack of slabs; (3) a “log” which is a precursor log wrapped with a jacket; and (4) a “log segment” which is a skin-coated log visible in the final raft structure.

The deck structure is also preferably core-formed from sheet foam material which has been cut (a) into one, central rectangular form (in the in the specific raft which is illustrated), accompanied by (b), an appropriate plurality of elongate, more slender slat-like forms which edge-join the central form, and each other, to define opposite ends of the ultimately constructed raft deck structure.

Appropriately applied and bonded to substantially all of the exposed, i.e., outer, surfaces—upper, lower and lateral—of the just-mentioned foam core structures, are thinner sheets of foam jacketing, also referred to herein as a jacket.

Extremely importantly, spray-applied over the entirety of the core assembly just outlined is a selected, elastomeric, polyurea coating. This very robust, high-protection encapsulating coating, referred to herein also as a penetration-barriering and fracture-resistant coating, preferably covers, binds together, stabilizes and protects the entirety of what may be thought of as the otherwise central, or inside-core, raft structure.

Further describing features of the proposed raft structure, essentially, this structure, and in particular its shape-establishing, or shape-defining, main body foam structure, includes plural, lateral-side, and bow-end and stern-end, elongate core assemblies that endo-unite to create raft-body, perimeter core structure. These elongate, perimeter core assemblies are formed of “log segments”, inasmuch as each has an elongate, somewhat (though not exactly) cylindrical, “log-like” configuration. In the particular raft embodiment which is illustrated and described in detail herein, there are two, elongate, lateral-side log segments, one on each side, and six each, elongate (but somewhat individually shorter) bow and stern log segments. The logs and log precursors extant within all log segments in a given raft structure are adhesively united end-to-end (i.e., endo) through, as will be explained below, angularly (non-right-angle) mitered-cut ends.

Uniquely, each log precursor is formed from an assembly of initially, individually water-jet-profile-cut, building-block slabs prepared from an initially flat sheet of a closed-cell foam material. Preferably, the material chosen to form these slabs is conventionally available PIE, or XPE-cross-linked P/E, lying in a range of about 1.2# to about 9#. For a preferred embodiment, we have chosen 1.2# P/E made by Sealed Air Corporation in New Jersey. Each slab preferably has a thickness somewhere in the range of about 2-inches to about 4-inches, depending, of course, on the starting thickness of the material from which the slabs are profile-cut. In the raft structure illustrated herein, each slab, just a few of which are specifically marked and labeled for illustration purposes, has a thickness of about 4-inches.

As can be seen in the accompanying drawings, which are still to be discussed in detail, the perimetral profile of each slab employed in the two, lateral-side logs differs somewhat from the perimetral profile of each slab employed in the bow and stern logs, with the former slabs including laterally inwardly facing, generally rectangular-cross-section slots, and the latter slabs including inwardly protruding, upwardly facing ledges, or shoulders. The just-mentioned slots and ledges in the differing slabs function to receive and support perimetral edges the raft's floor structure. In a fully assembled raft, the central, lateral-side edges of such floor structure are received in the lateral-side slabs' mentioned slots, and the bow and stern edges of the floor structure are supported on the bow and stern slabs' mentioned ledges, together forming combined raft-body, perimeter core structure and floor structure.

The raft floor structure illustratively employed herein is formed preferably of an appropriate rigid, or semi-rigid, conventional foam material, such as 6# PET.

Formed in each log slab, as will be seen and more fully described, are two, spaced and offset, circular (other shapes may be used), indexing holes (registry through-apertures), through which elongate, cylindrical, preferably 2.0# PIE foam registry rods (or pins) are threadingly inserted, under interference-fit conditions, during assembly of an associated, preliminary log. As will be explained, preliminary logs are, following initial formation, appropriately angularly end-mitered-cut for the necessary, angular, end-to-end fabrication of the preliminary, united log core assemblies and the floor structure. Typical registry-aperture diameters preferably lie in the range of about 3-inches to about 6-inches, with the specific raft shown herein employing 6-inch diameter apertures and rods.

The selection here to use preferentially the mentioned, two, circular-cross-section through-apertures has been based upon (a) the ultimate simplicity of employing readily available, elongate, cylindrical registry pins, and (b) the fact that the presences of two such apertures, spaced apart as stated, eliminate the possibility of relative rotational misalignment occurring in the perimetral profiles of adjacent log slabs.

With the “sandwich-stacked” preliminary log slabs, which are to participate with jacketing structure, still to be discussed, to form, shape-definingly, the lateral-side, and the bow and the stern, portions of a raft, united and indexed by registry-aperture-inserted rods (with or without an optional adhesive employed in the interfacial regions between the slabs and rods in a log assembly), and with these assembled, preliminary logs appropriately angularly miter-precut at their ends, they are end-to-end assembled (as by surface-adhesive bonding) to form the central portion of the mentioned, raft-body, perimeter core structure. Other perimeter-structure raft configurations than the one pictured in the illustrative drawings herein are, of course, possible, as desired.

Following core preliminary-log-structure and floor-structure assembly to form a combined, raft-body perimeter core structure and floor structure, most of this entire assembly is suitably jacketed, via suitable adhesive bonding, with an a moderately thin, solid foam buoyancy material, such as conventional PIE or XPE ½-inches thick sheet foam material.

Thereafter, the important, high-protection-quality, elastomeric surfacing skin material, preferably polyurea, as mentioned above, is spray-applied to a thickness preferably of about 80-mils as an all-over overcoating and core-stabilizing structure. Here, a preferred material takes the form of UBERLINER® Polyurea made by Specialty Products, Inc. in Lakewood, Wash.

We also recognize that, in certain instances, and for certain applications, various tough polyurethane coating materials could here be employed.

These and other features and advantages of the structure and methodology of the present invention will become more fully apparent as the detailed description which now follows is read in conjunction with the accompanying drawings.

### DESCRIPTIONS OF THE DRAWINGS

FIG. 1 is a top, isometric view of a raft, or raft structure, constructed in accordance with a preferred and best-mode embodiment of the present invention—made in accordance with the preferred and best-mode manner of practicing the raft-construction methodology of the invention.

FIG. 2 is a fragmentary, top plan view of the raft pictured in FIG. 1 with portions of perimeter structure in the stern and opposite lateral-side areas of the raft partially broken away to illustrate certain details of internal construction.

FIG. 3 is a side elevation taken from the lower side of FIG. 2 with certain central portions of the illustrated raft structure broken away to illustrate details of internal construction.

FIG. 4 is a stern-end elevation taken from the left side of FIG. 3. The right-side, bow-end elevation presents the same appearance.

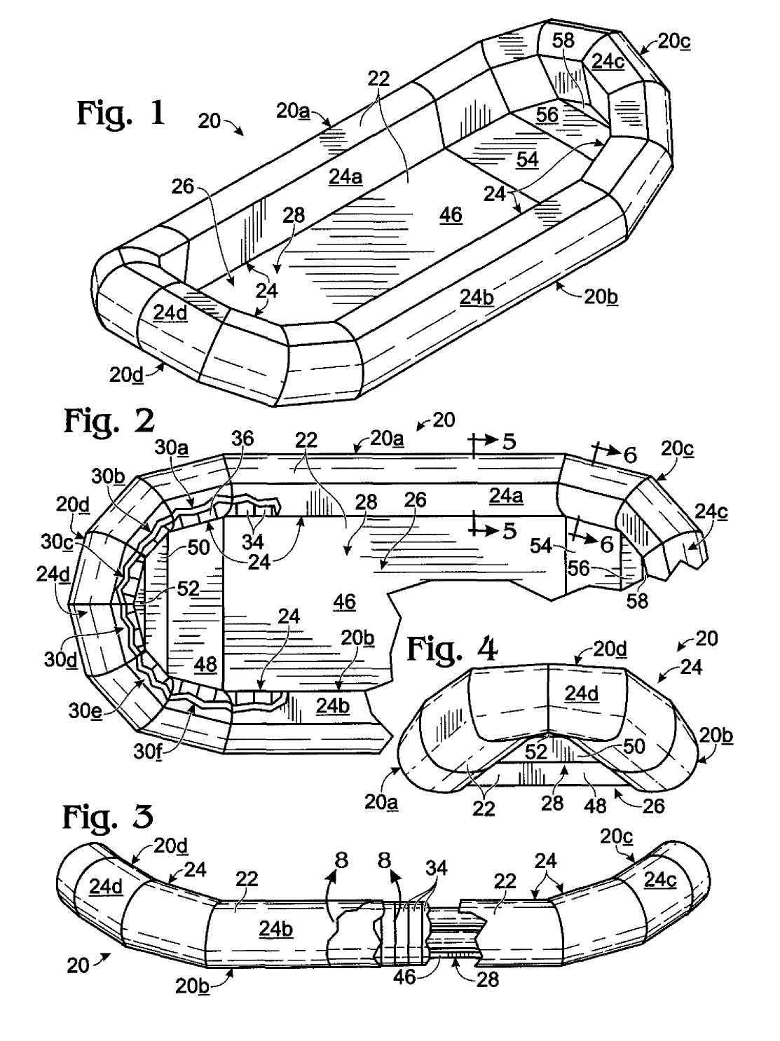

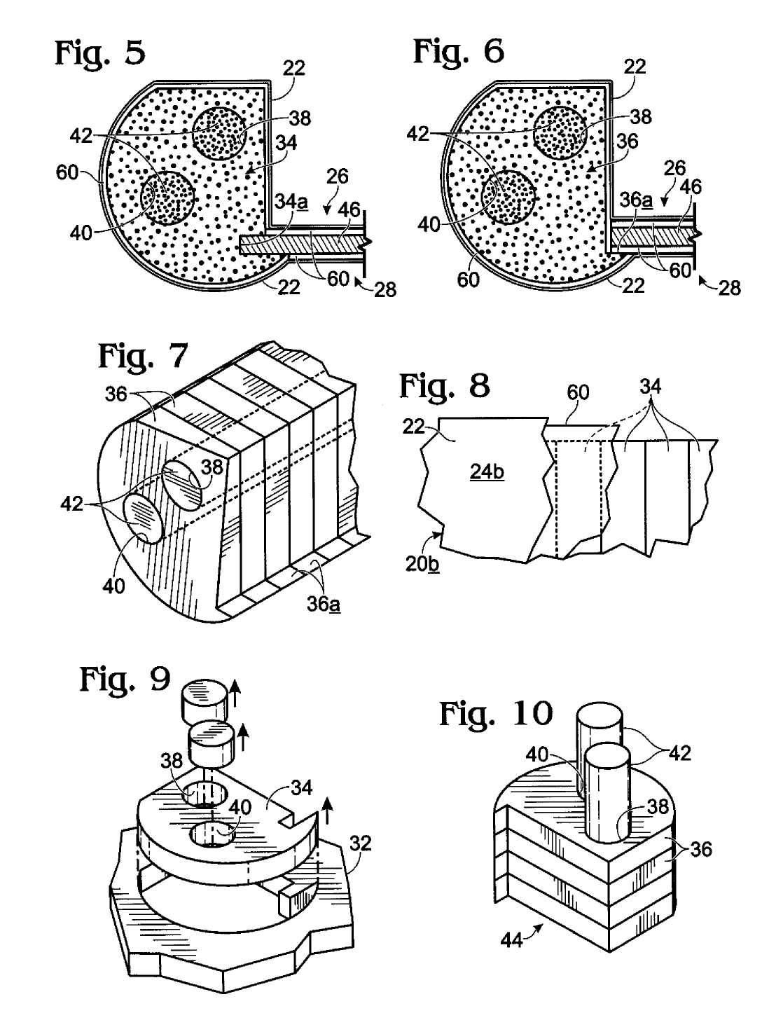

In FIGS. 1-4, various angularly intersecting, solid lines are employed that appear on the surfaces of different portions of the pictured raft to help illustrate the specific presences of individual “log” segments that are included as portions of the perimeter and deck structures in the raft. It should be understood that, as has been mentioned above, and as will be explained in greater detail below, the entire outside surface of the raft—top, lateral, end and bottom—is coated with an important, sprayed-on skin coating of elastomeric polyurea material, the presence of which material, while permitting a certain amount of core-log and deck-panel joinder-line, or edge, telegraphing for appearance on the outside of the raft, actually tends to “soften” these apparent edges considerably.

FIG. 5, which is drawn on a larger scale than that employed in FIG. 2, is a cross-sectional view taken generally along the line 5-5 in FIG. 2. This view is taken specifically through one lateral-side log segment in the perimeter structure included in the raft of the present invention.

FIG. 6 is a cross-sectional view, drawn on about the same scale as that which is employed in FIG. 5, taken generally along the line 6-6 in FIG. 2. This view is taken through one of the six bow-end perimeter-structure log segments included in the raft of the invention.

FIG. 7 presents a fragmentary and isolated view of a portion of one of the two, raft-included, lateral, perimeter-structure log precursors, or preliminary logs, shown here including a registry-pinned, fragmentary sandwich stack of plural, profiled foam log slabs, formed at a somewhat early stage in the assembly of the raft components.

FIG. 8 presents a fragmentary, enlarged view, with portions broken away, generally picturing the area embraced by the two, curved, arrow-headed lines 8-8 seen the FIG. 3.

FIGS. 9 (an exploded view) and 10 (a preliminary registration-assembly view) generally picture certain steps involved in raft-construction methodology of the invention.

One should note that components and features of the raft pictured in these drawing figures are not necessarily drawn to scale.

### DETAILED DESCRIPTION OF THE INVENTION

Turning now to the drawings, and referring first of all to FIGS. 1-8, inclusive, indicated generally at 20 is a non-inflated, penetration-barriering and fracture-resistant, polyurea, spray-applied-skin-22 coated, solid-body raft constructed in accordance with the raft-construction methodology of the present invention. This raft, which is distinguished, among other significant ways, by having the importantly skin-coated, principal, shape defining, or establishing, components that make up its form constructed preferably entirely of solid, buoyancy-material foam, has opposite, lateral sides 20a, 20b, and bow and stern ends 20c, 20d, respectively. As can be seen especially well in FIGS. 2-4, inclusive, the particular raft which is pictured herein, and which looks a bit like a familiar, conventional-style inflated raft, but is, of course, not, is (in its overall body structure) both bilaterally and longitudinally symmetrical, in the sense that it appears the same from each of its two lateral sides, and from each of its ends.

While specific dimensionality is not a feature of the present invention, raft 20 herein has an overall length for illustration purposes of about 18-feet, a width of about 8-feet, an overall height, if one takes into account the gently upwardly rising opposite ends from the base of the raft, of about 36-inches. It has a weight of around 300-pounds.

Raft 20 is pictured herein without the inclusion of any additional hardware, such as transverse seating structure, motor-mount structure, oarlock structure etc., none of which forms any part of the present invention. One should understand, of course, and those skilled in the art will readily appreciate, that modified forms (shapes, motive-power design, etc.) of the invention, including a modified form which is constructed with a stern end capable of supporting a motor, may readily be made without departing from the spirit of the present invention.

Among the many features which distinguish the structure, and indeed the construction methodology, associated with the present invention is that, effectively, and with the exception of the important protective and structurally-stabilizing spray-applied overcoating which will be described below herein, the entire structural body of the raft is formed of several different specific and preferred kinds of solid, buoyancy foam materials, all such materials having been mentioned specifically above herein, and all of which, save the elongate, cylindrical registry pins, or rods, have originated in sheet form from which appropriate shapes have been cut to construct the various component parts and elements of the raft body structure. Such principal, “from-sheet-form” construction obviously contributes to a very efficient and excellent cost-managing approach toward the making of the raft of the invention, avoiding, as it clearly does, any special molding or other especially expensive component-shaping processes. As will also become apparent from the description which follows below, the overall componentry, viewed as individual elements, is extremely simple in construction, and is placed together, or assembled, in terms of its plural parts, also in a very straightforward, easy, and relatively inexpensive, and speedy manner. The all-important skin coating 22 functions, among other significant things, to bind together and stabilize the internal, foam core components.

In general terms, raft 20 includes an endless-loop perimeter structure 24 which circumsurrounds and defines an elongate central, and somewhat ovate, deck zone 26, the base of which is formed by a floor, or deck, structure 28 which is mechanically and adhesively attached to the perimeter structure in manners which will also shortly be described.

Perimeter structure 24 includes a pair of lateral structures 24a, 24b, also referred to as log segments, including, immediately beneath skin coating 22, what we refer to herein as elongate logs, and plural-log-segmented, bow and stern end structures 24c, 24d, respectively, each having, from a plan, overhead point of view, as seen in FIG. 2, of a kind of semi-circular shape, formed by what is referred to herein as endo adhesive bonding of plural (six each), slightly wedge-shaped, similar logs, such as the six logs shown at 30a, 30b, 30c, 30d, 30e, 30f for structure 24d. These six logs which make up bow and stern portions of perimeter structure 24 differ from one another slightly in length and wedge shape in order to enable production of raft 20 with the laterally curving and upwardly “rising” opposite ends, with logs 30a, 30f having essentially the same lengths and mirror-image shapes, logs 30b, 30e likewise having similar lengths and mirror-image shapes, and logs 30c, 30d also having similar lengths and mirror-image shapes. As was just mentioned, those skilled in the art understanding the structure of raft 20 will readily appreciate that more or less than the just-mentioned six end-structure logs may be employed, and they may be length and wedge shaped appropriately to come together to form different specifically configured bow and stern raft ends.

Continuing now with a description of the structure of raft 20 in association with a companion description of the raft-construction methodology which is employed in accordance with the present invention, and beginning first of all with that portion of this methodology which is associated with creating the perimeter structure components, sheets, such as fragmentarily shown sheet 32 in FIG. 9, of 4-inches thick, closed-cell, 1.2# PIE foam material are placed appropriately in a work zone suitable for the component-formation tasks to be performed. These sheets are there preferably water-jet cut in a way to define within them the respective perimetral profiles of the two different shapes of log slabs which are, following cutting, to be excised from the sheets, and then arranged in appropriate sandwich stacks to produce, ultimately, the logs that are employed to create the desired perimeter structure.

FIGS. 5 and 6 illustrate, at 34, 36, respectively, the two, different log slabs, and specifically their respectively associated profiles, or perimetral outlines, that are to be employed in the constructions of the precursor logs which are used in the lateral sides, and in the bow and stern ends, respectively, in raft 20. As can be seen in FIG. 5, the profile of log slab 34 includes a laterally inwardly (relative to the outside of raft 20) facing slot 34a which, as mentioned earlier herein, is adapted to receive, and in FIG. 5 is shown receiving, an inserted lateral edge portion of deck structure 28. Somewhat similarly, and as can be seen in FIG. 6, the profile of log slab 36 includes a laterally inwardly (also relative to the outside of raft 20) projecting and upwardly facing ledge, or shoulder, 36a which is adapted to receive, and in FIG. 6 is shown receiving, a seated end edge portion of deck structure 28.

FIG. 9 pictures water-jet profiling and excising of a lateral log-slab 34. A similar figure, not specifically presented herein, but clearly understandable to those generally skilled in the relevant art, could be employed to illustrate the same situation for a raft-end log slab

The outlines of these slabs are cut into and through these sheets, as are also the illustrated, matching-position (in all log slabs), circular-outline, spaced and offset, through-slab registry apertures, such as those shown at 38, 40, and the slabs, along with the aperture “cutouts” (approximately 4-inches in diameter herein), are appropriately removed (from the sheets and the slabs, respectively), with the aperture-cleared slabs then separated into collections of the two different profiles that are relevant, respectively, to the lateral, and to the bow and stern, portions of the perimeter structure. Such removal, or excising is illustrated in FIG. 7 by three, short, upwardly pointing arrows. In the embodiment of the raft invention now being described, apertures 38, 40 are disposed with, in each slab, aperture 38 disposed above and laterally inwardly of aperture 40. This selected, relative positioning of the apertures is merely a matter of current preferred choice, but not critical. Also, and as has already been generally (at least partially) mentioned, more or less than two registry apertures could be employed, and in different “openings”-sizes could also be chosen, with the understanding that a decision to use but a single aperture would preferably be accompanied by a decision further to shape such a singularity non-circularly in order to minimize adjacent log-slab relative-rotation and misalignment during the construction process.

Focusing especially on FIGS. 7 and 10, with the log slabs and registry through-apertures so prepared, and noting that these two “representative” drawing figures, which feature illustrations specifically of log-slabs 36, could essentially be “replicated” (but, for drawing economy sake, are not herein) to feature illustrations of log slabs 34, appropriately-diametered (about 4-inches) registry pins, or rods, such as those shown at 42, which are cylindrical and elongate in nature, and formed of 2.0# PIE foam as mentioned above herein, and which may be extruded structures, are frictionally threaded through stacks prepared of the log slabs (see especially FIG. 10 which pictures a partially established and “threaded-through stack) to create pinned-together, and profile and aperture registered, sandwiched log-slab stacks, such as the illustrated sandwich stack 44 of log slabs 36.

In a modified form of raft structure, pins 42 could be made of any appropriate, elongate relatively rigid material, such as FRP (Fibre Reinforced Plastic), or a suitable metal, tubing.

The log slabs in such stacks are disposed immediately adjacent and in contact with one another, but preferably not bonded to each another—a bonding which has been found not to be necessary. These assemblies of pinned-together log slabs are prepared in such a fashion as to have appropriate sets of overall lengths suitable for thereafter endo, non-right-angular miter-cross-cutting and trimming into the appropriate lengths for assembly into the raft perimeter structure. Preferably, the registry pins which have been threaded into the stacks of slabs protrude at least slightly from opposite ends of these assemblages prior to miter cross-cutting. FIG. 7 fragmentarily illustrates such a stack assemblage whose near end in the figure has been non-right-angularly miter cut. Miter cross-cutting, of course, produces flush, log-precursor ends, as can be seen clearly in this drawing figure, which ends enable appropriate, subsequent endo adhesive bonding of adjacent precursor logs. Such a miter-cut stack constitutes herein a precursor, or preliminary, log.

As was pointed out earlier, angular miter cross-cutting is performed at selected, appropriate angles to enable raft perimeter-structure assembly with the correct, user-designed configuration. It will also be apparent to those skilled in the art that the specific number of lateral, bow and stern precursor logs that are prepared for assembly are matters of user and designer choice.

Looking now more specifically at FIGS. 1-6, inclusive, deck structure 28 in raft 20 is formed with seven, planar panels, including (a) a large central panel 46 which has a length in the raft substantially matching the lengths of the lateral log-precursor structures in perimeter structure 24, (b) three, elongate, stern-end panels, shown at 48, 50, 52, of progressively smaller size progressing longitudinally outwardly from central panel 46, and (c) three, similar, elongate bow-end panels shown at 54, 56, 58.

As was mentioned earlier, these seven deck-structure panels are preferably formed from 2-inches thick, 6# PET conventional sheet foam material. Alternative deck-structure materials could include plywood, composite structural panel materials, or others.

With the perimeter log-precursor structures essentially fully formed, and with the six, specific log precursor structures which are employed to make up each of the bow and stern ends of raft 20 endo bonded to one another, (1) central panel 46 in the deck structure has its lateral edges slidably inserted into, and adhesively bonded appropriately within, the inwardly laterally facing slots, such as slot 34a, in the lateral-side log-precursor structures, (2) the formed bow- and stern-end log-precursor structures are then appropriately log-precursor-endo-bonded to the appropriate opposite ends of the lateral log-precursor structures, and (3) thereafter, and in an appropriate succession, the elongate and narrower deck-structure panels that are be employed adjacent the opposite ends of the raft are lowered into place within deck zone 26, and adhesively bonded, both along their adjacent edges to one another, and in conditions resting on and supported by the ledges, such as previously mentioned ledge 36a, in the raft-end log-precursor perimeter-structure assemblies.

Next, sheets of ½-inches thick, conventional PIE or XPE foam, appropriately pre-prepared in the correct sizes, are (a) wrapped around the pinned-together stacks of precursor log slabs, and (b) surface-applied to the upper and lower surfaces of the deck-structure panels, as seen in FIGS. 5 and 6, and bonded thereto through an appropriate contact adhesive, so as to produce jacketing 60.

Finally, an all-over, fully encapsulating, preferably 80-mils-thick skin coating of the above-identified polyurea material id suitably spray applied to create the very important penetration-barriering and fracture-resistant skin coating whose functions have been described above.

Accordingly, while a preferred raft structure, and a preferred, associated construction methodology therefor, have been specifically illustrated and described herein, and certain modifications suggested, we recognize that other variations and modifications may be made within the spirit of the invention.

We claim:

1. A non-inflatable raft with an encapsulating, polyurea skin coating.

2. A robust-skin-encapsulated, non-inflatable raft comprising
shape-establishing core body structure in the form of an assembly including (a) perimeter structure defining, and at least partially circumsurrounding, a deck zone, and (b) deck structure joined to said perimeter structure within said deck zone, and
an encapsulating, penetration-barriering and fracture-resistant, polyurea skin coating applied to said core body structure.

3. The raft of claim 2, wherein said perimeter and deck structures are formed, each, of plural, solid-foam, buoyancy-material components, and said skin coating operatively unites and configurationally stabilizes the assembly of said components.

4. The raft of claim 3, which further comprises a solid-foam buoyancy-material jacket disposed operatively intermediate said core body structure and said skin coating.

5. A raft comprising
a core body structure including (a) perimeter structure formed with a solid-foam, buoyancy-material core defining and circumsurrounding a deck zone, and (b) deck structure formed with a solid-foam, buoyancy-material core, joined to said perimeter structure within said zone, and
operatively associated with said core body structure, an encapsulating, spray applied skin coating formed of one of a polyurea material and a polyurethane material.

6. A raft comprising
a threaded-slab, buoyancy-material, perimeter structure defining a central, broad-area deck zone, and
deck structure joined to said perimeter structure and at least partially spanning said deck zone.

7. The raft of claim 6, wherein said perimeter structure takes the form of an elongate, endless loop.

8. The raft of claim 6, wherein said perimeter structure internally takes the form of plural, elongate, endo-joined, lateral, bow and stern log segments each including plural, stack-threaded, buoyancy-material slabs.

9. The raft of claim 6, wherein (a) each log includes a long axis, (b) each slab in each log possesses a perimetral profile which is specific to the character of the log, and includes a pair of spaced, slab-to-slab ailgnable and complementary, registry-accommodating through-apertures, and (c), included in each log are elongate, buoyancy-material registry threading pins extending substantially the full length of the log frictionally through and aligning the ailgnable apertures, and thereby registering the relative positions of the slabs.

10. The raft of claim 9, wherein, within each log, the slabs therein are unbonded to one another.

11. The raft of claim 9, wherein, with said raft occupying substantially a horizontal disposition, said apertures in each slab are spaced both vertically and horizontally relative to one another.

12. The raft of claim 11, wherein said apertures in said slabs include upper and lower apertures, respecting which said upper aperture is disposed outboard of said lower aperture.

13. The raft of claim 8, wherein said deck structure includes lateral, bow and stern edges, and said slabs in said logs are perimetrally profiled with inboard-disposed, support-reception regions for receiving and supporting said edges.

14. The raft of claim 13, wherein said support-reception regions in the slabs within said lateral logs are defined by laterally-inboard-facing slots which face said deck zone, and said support-reception zones in the slabs within said bow and stern logs are defined by upwardly facing ledges.

15. The raft of claim 8, wherein, within each log, the slabs therein are unbonded to one another.

16. The raft of claim 6 which further comprises an all-over, fully encapsulating coating of spray-applied high elastomeric material.

17. Raft constructing methodology comprising
from selected, sheet-form buoyancy material, excising and extracting predetermined predeterminedly perimetrally profiled slabs,
creating in each such slab plural, through-slab, registry apertures,
stack-assembling, into an elongate assemblage, or plural elongate assemblages, plural, registry-apertured slabs with profiles and registry apertures registry-aligned, respectively, with one another,
threading elongate, buoyancy-material registry pins into the aligned registry apertures in each such assemblage to produce thereby a plural-slab, raft-perimeter-structure, log-precursor,
appropriately cross-cutting each log-precursor into predetermined-length, endo-configured, elongate log precursors,
endo-bonding selected, endo-configured, elongate log precursors to form perimeter core structure of the intended raft, and doing this so as to define a circumsurrounded deck zone, and
establishing a deck within the defined deck zone.

18. Raft constructing methodology comprising
forming from solid-foam buoyancy material a plural-slab, pin-registered raft perimeter structure which defines a circumsurrounded deck zone, and
within the defined deck zone attaching a deck structure which is also formed of solid-foam buoyancy material.

19. The constructing methodology of claim 18, wherein said forming and attaching are followed ultimately by spray-coating the entireties of the perimeter and deck structures with an encapsulating, high-elastomeric, polyurea coating material.
